(19) United States
(12) Patent Application Publication
(10) Pub. No.: US 2009/0033834 A1
(43) Pub. Date: Feb. 5, 2009

(54) LIQUID CRYSTAL LAYER FORMING INK COMPOSITION, AND OPTICAL FILM, POLARIZING FILM AND LIQUID CRYSTAL DISPLAY PRODUCED WITH THE INK COMPOSITION

(76) Inventor: Takashi Kuroda, Tokyo (JP)

Correspondence Address: LADAS & PARRY LLP, 224 SOUTH MICHIGAN AVENUE, SUITE 1600, CHICAGO, IL, 60604, US

(21) Appl. No.: 11/816,305

(22) PCT Filed: Feb. 16, 2006
(86) PCT No.: PCT/JP2006/302747

§ 371 Date: Aug. 15, 2007

(30) Foreign Application Priority Data
Feb. 18, 2005 (JP) 2005-043240

(51) Int. Cl. G02F 1/1335; C09K 19/00; G02F 1/13

(52) U.S. Cl. 349/76; 252/299.01; 349/193

(57) ABSTRACT

An ink composition capable of forming a liquid crystal layer even on a base material with no alignment treatment applied; and an optical film, a polarizing film and a liquid crystal display produced using the ink composition. The liquid crystal layer forming ink composition has a liquid crystalline molecular material, an organic solvent for dissolving or dispersing the molecular material, and an alcohols solvent. By applying the ink composition on a base material, drying, and aligning the liquid crystal molecule material, an optical film with a liquid crystal layer formed can be obtained. Since the alcohols solvent is contained in the liquid crystal composition, the liquid crystalline molecular material is in a state horizontally aligned on the base material, and the optical film can have a high transparency.

### TECHNICAL FIELD

The present invention relates to an ink composition to be used at the time of forming a liquid crystal layer (hereafter, it is abbreviated as “liquid crystal layer forming”), and an optical film, a polarizing film and a liquid crystal display produced using the ink composition.

### BACKGROUND ART

As to the liquid crystal materials having optical activities, such as cholesteric liquid crystals, utilization for many applications such as various optical films, polarizing films and liquid crystal display has been discussed. At the time of forming the liquid crystal material on a substrate as a film as a liquid crystal layer, in general, the liquid crystal molecules need to be aligned in a certain sequence.

As a method of aligning the above-mentioned liquid crystal molecules, the methods shown below have been conventionally known. As one of the methods, there is a method of forming an inorganic film on a substrate by depositing an inorganic material such as silicon oxide from an oblique direction for aligning the liquid crystal molecules in the depositing direction. According to the method, although stable alignment with a certain tilt angle can be obtained, it is not industrially efficient. Moreover, as another method, there is a method of providing an organic coated film on a substrate surface, and scrubbing the surface with a cloth of cotton, nylon, polyester or the like in a certain direction, that is, to perform rubbing, for aligning the liquid crystal molecules in the rubbing direction. Since stable alignment can be obtained according to the method relatively simply, this method is often adopted industrially. As the organic coated film, resins of polyvinyl alcohol, polyoxy ethylene, polyamide, polyimide or the like can be presented. From the viewpoint of the excellent chemical stability, thermal stability and other factors, polyimide is used most commonly. Moreover, there is a method of applying a liquid crystal material on a drawn plastic film, and aligning the liquid crystal molecules along the drawing direction.

According to the above-mentioned method of rubbing the organic coated film on the substrate, an aligned film of an organic coated film is provided between the substrate and the liquid crystal layer, so that grave shortcoming of the display defect, caused by the scratch of the alignment film surface due to the fluff generated (surface roughness) by friction against the surface at the time of the rubbing alignment treatment or dust generation from the rubbed surface, occurs. Thus, a problem of the production yield decline is involved. Moreover, in the case of aligning the liquid crystal molecules by use of the above-mentioned drawn plastic film, the base material of the drawn plastic film itself may adversely affect the optical characteristics which are required as the physical properties for the purposed optical film.

According to the above-mentioned alignment methods which utilize the alignment limiting force obtained by the alignment treatment applied on the substrate (base material) by forming an alignment film on the substrate (base material) or using a base material with the drawing treatment applied as the base material, the above-mentioned problems are generated in any method. On the other hand, the so-called “rubbingless” alignment method of aligning the liquid crystals without rubbing has been discussed and various methods have been proposed. For example, the patent document 1 discloses a method of introducing photochromic molecules to an alignment film surface and aligning the molecules on the alignment film surface by a light beam. There is also a method of aligning molecular chains constituting an alignment film using a Langmuir-Blodgett film (see the non-patent document 1) The patent document 2 discloses a method of pressing an alignment film on a substrate with a preliminarily alignment treatment to transfer the alignment. However, in consideration to the industrial productivity, these methods cannot be a substitute of the rubbing method.

As a method of aligning a liquid crystal material without utilizing the limiting force of the alignment obtained by the alignment treatment applied to the base material, the patent documents 3 and 4 have been proposed. However, an optical film produced by these methods involves the problems of the insufficient transparency, a high Haze, and a low contrast when it is viewed from the front side.
[Patent document 1] Japanese Patent Application Laid-Open (JP-A) No. 4-2844
[Patent document 2] JP-A No. 6-43458
[Patent document 3] JP-A No. 2003-29037
[Patent document 4] JP-A No. 2003-185827
[Non patent document 1] S. Kobayashi et al., Jpn, J. Appl. Phys. 27, 475 (1988)

### DISCLOSURE OF THE INVENTION

### Problems to be Solved by the Invention

Therefore, in order to solve the above-mentioned problems, an object of the present invention is to provide: an ink composition capable of forming a liquid crystal layer even on a base material with no alignment treatment applied, capable of obtaining a high contrast display when it is viewed from the front side, having a low Haze, capable of satisfying the physical properties required for the optical characteristics of an optical film, having a high production yield, and efficient and stable in terms of the industrial productivity; and an optical film, a polarizing film and a liquid crystal display produced using the ink composition.

### Means for Solving the Problems

The invention recited in claim 1 is a liquid crystal layer forming ink composition characterized by containing a liquid crystalline molecular material, an organic solvent for dissolving or dispersing the molecular material, and an alcohols solvent. The invention recited in claim 2 is characterized in that the liquid crystalline molecular material recited in claim 1 is a nematic liquid crystalline molecular material and further contains a chiral agent. Further, the invention recited in claim 3 is characterized in that the liquid crystalline molecular material recited in claim 1 has a polymerizable functional group.

The invention recited in claim 4 is an optical film characterized in that a liquid crystal layer is formed by: applying the liquid crystal layer forming ink composition according to any one of claims 1 to 3 on a base material with no alignment treatment applied, and drying for removing the organic solvent and the alcohols solvent of the ink composition so as to align the liquid crystalline molecular material. Further, the invention recited in claim 5 is an optical film characterized in that a liquid crystal layer is formed by: applying the liquid crystal layer forming ink composition according to claim 3 on a base material with no alignment treatment applied, and drying for removing the organic solvent and the alcohols solvent of the ink composition so as to align the liquid crystalline molecular material, followed by immobilization.

Moreover, the invention recited in claim 6 is an optical film characterized in that a liquid crystal layer with the liquid crystalline molecular material aligned is formed by: applying the liquid crystal layer forming ink composition according to any one of claims 1 to 3 on a base material with an alignment treatment applied, and drying for removing the organic solvent and the alcohols solvent of the ink composition. The invention recited in claim 7 is an optical film characterized in that a liquid crystal layer is formed by: applying the liquid crystal layer forming ink composition according to claim 3 on a base material with an alignment treatment applied, and drying for removing the organic solvent and the alcohols solvent of the ink composition so as to align the liquid crystalline molecular material, followed by immobilization.

Moreover, the invention recited in claim 8 is a polarizing film comprising the optical film according to any one of claims 4 to 7 attached with a polarizing layer. Lastly, the invention recited in claim 9 is a liquid crystal display characterized in that the optical film according to any one of claims 4 to 7, or the polarizing film according to claim 8 is arranged on an optical path.

### EFFECT OF THE INVENTION

A liquid crystal layer forming ink composition of the present invention is characterized by containing a liquid crystalline molecular material, an organic solvent for dissolving or dispersing the molecular material, and an alcohols solvent. By applying the ink composition on a base material, and drying for removing the organic solvent and the alcohols solvent of the ink composition, the liquid crystalline molecular material is aligned so that an optical film on which a liquid crystal layer is formed can be obtained. When the liquid crystal layer forming ink composition is applied onto a base material such as a cellulose based resin, since the liquid crystalline molecular material of the ink composition is dissolved or dispersed by the organic solvent, and also since the alcohols solvent is contained, the liquid crystalline molecular material is in a state horizontally aligned to the base material, an optical film with a high transparency, that is, a low Haze, and a high contrast display when viewed form the front side can be obtained.

### BRIEF DESCRIPTION OF THE DRAWINGS

FIG. 1 is a cross-sectional view showing an example of an optical film of the present invention.

FIG. 2 is a cross-sectional view showing another example of the optical film of the present invention.

FIGS. 3A and 3B are each a schematic diagram for explaining a positive A plate and a negative C plate.

FIG. 4 is a schematic exploded perspective view showing an example of a liquid crystal display comprising the optical film of the present invention.

### EXPLANATION OF REFERENCES

1 optical film
2 base material
3 liquid crystal layer
4 intermediate layer
10 optical film
20 liquid crystal display
102A polarizing plate on the incident side
102B polarizing plate on the outgoing side
104 liquid crystal cell 104

### BEST MODE FOR CARRYING OUT THE INVENTION

The present invention covers a liquid crystal layer forming ink composition, and an optical film, a polarizing film and a liquid crystal display produced using the ink composition. Hereafter, each of them will be explained in detail.

### A. Liquid Crystal Layer Forming Ink Composition

The liquid crystal layer forming ink composition of the present invention comprises a liquid crystalline molecular material, an organic solvent for dissolving or dispersing the molecular material, and an alcohols solvent. As the liquid crystalline molecular material, a nematic liquid crystalline molecular material, a cholesteric liquid crystalline molecular material and a discotic liquid crystalline molecular material can be used, and among them, those having a polymerizable functional group in the molecule can be used preferably. In particular, those having a three-dimensionally cross-linkable polymerizable functional group are preferable.

This is because those having a polymerizable functional group can polymerize (cross-link) the liquid crystalline molecular material in a plastic film by the function of the radical generated from the photo polymerization initiating agent through light irradiation, the electron beam or the like after being supplied into the plastic film, so that a trouble of such as bleeding out of the liquid crystalline molecular material over time can be prevented so as to enable the stable use. The “three-dimensional cross-linking” denotes three-dimensional polymerization of the liquid crystalline molecules with each other so as to be in a state of a mesh (network) structure.

Although the above-mentioned polymerizable functional group is not particularly limited, a polymerizable functional group to be polymerized by the function of a radical generated from the photo polymerization initiating agent through the ultraviolet ray irradiation can be used. Specifically, a functional group having at least one ethylenically unsaturated double bond capable of addition polymerization can be presented. Further specifically, a vinyl group, an acrylate group or the like, having or not having a substituent can be presented. As the liquid crystalline molecular material in the present invention, in particular, a liquid crystalline molecule which has a rod-like molecular structure and having the polymerizable functional group at the end can be used preferably. For example, by use of a nematic liquid crystalline molecule having polymerizable functional groups at both ends, a mesh (network) structure state can be provided by the three-dimensional polymerization to each other so that a liquid crystal layer immobilized further firmly can be obtained.

Specifically, a liquid crystalline molecular material having an acrylate group at the end can preferably be used. Specific examples of the nematic liquid crystalline molecules having an acrylate group at the end include the following chemical formulae III. In the case of the liquid crystalline monomer represented by the general chemical formula II, “X” is preferably 2 to 5 (integer).

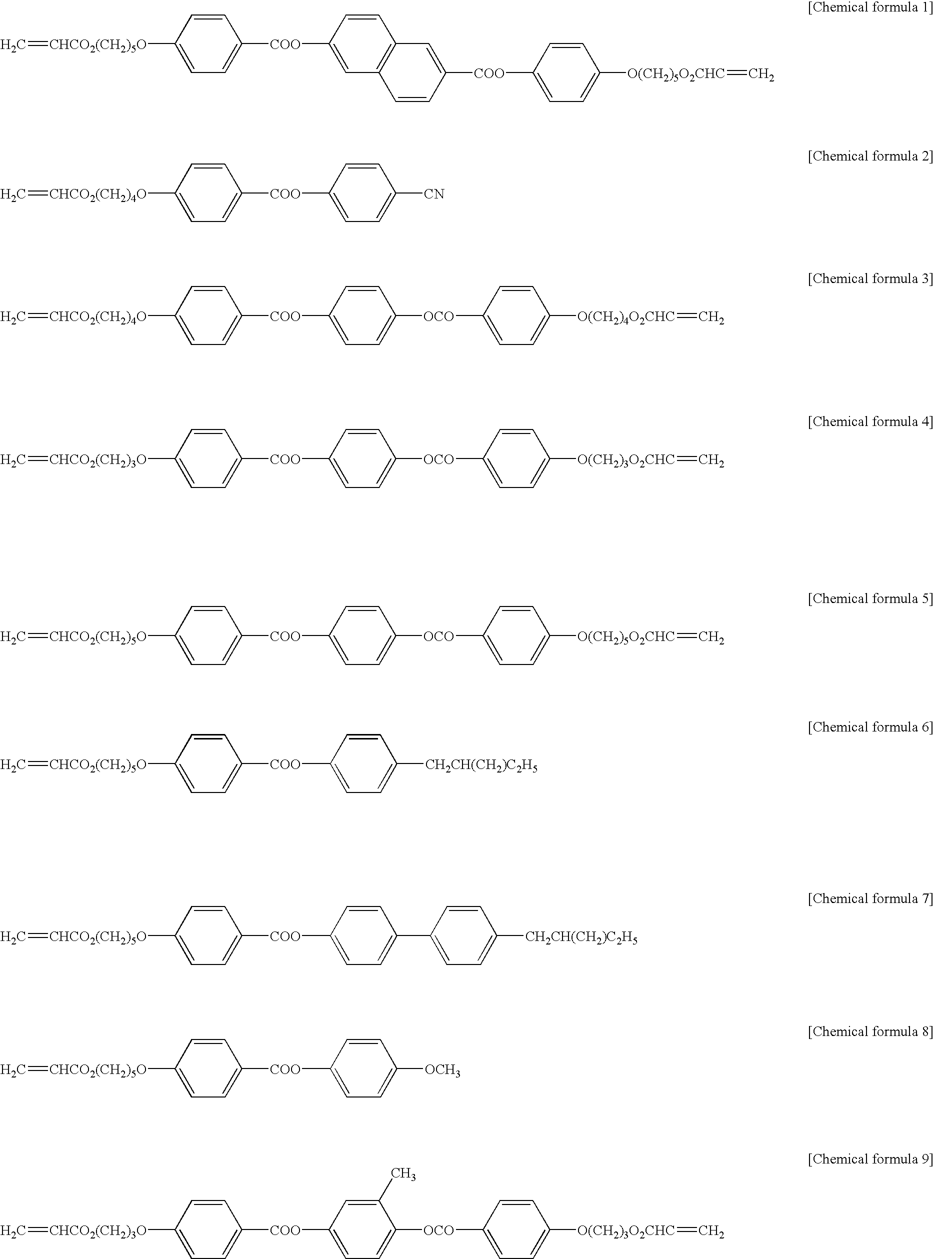

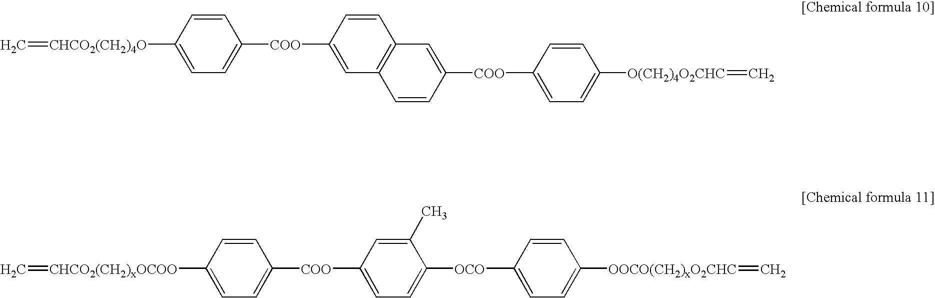

In the present invention, a chiral nematic liquid crystal having the cholesteric regularity with a chiral agent added to a nematic liquid crystal can be preferably used. The chiral agent denotes a low molecular compound having an optically active portion of a 1,500 or less molecular weight. The chiral agent is used mainly for the purpose of inducing a spiral pitch to the positive uniaxial nematic regularity of the nematic liquid crystalline molecular compound. As long as the purpose is achieved, and as long as it is compatible with the nematic liquid crystalline molecular compound in a solution state or in a molten state, and capable of inducing a desired spiral pitch thereto without deteriorating the liquid crystalline properties of the polymerizable liquid crystalline compound that can have the nematic regularity, the kind of the low molecular compound as the chiral agent is not particularly limited. However, it is preferable to respectively having a polymerizable functional group at both ends of the molecule in terms of obtaining an optical element having good heat resistance properties.

It is essential that the chiral agent used for inducing the spiral pitch to the liquid crystals has at least any chirality in the molecule. Therefore, examples of the chiral agent to be used in the present invention include a compound having one or at least two asymmetric carbons, a compound having an asymmetric point on a hetero atom such as a chiral amine and a chiral sulfoxide, and a compound with axial asymmetry such as cumulen and binaphthol. As the chiral agent, for example, a chiral agent represented by the general chemical formulae 12 to 14 can be used. In the case of a chiral agent represented by the general chemical formulae 12 and 13, “X” is preferably 2 to 12 (integer), and in the case of a chiral agent represented by the general chemical formula 14, “X” is preferably 2 to 5 (integer).

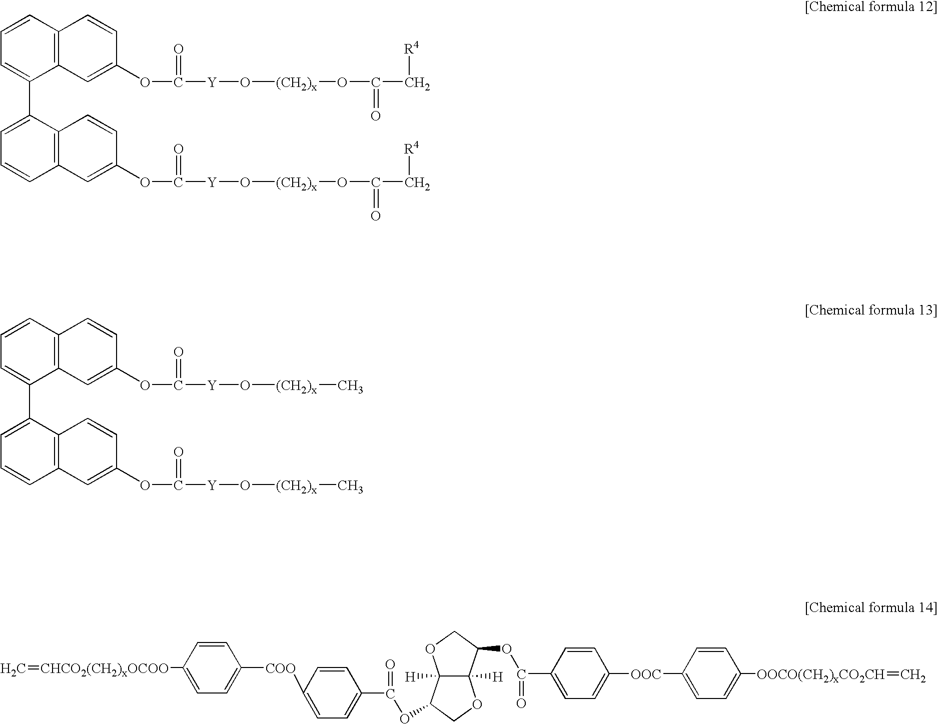

As the liquid crystalline molecular material, a discotic (disk-like) liquid crystalline molecular material can be used. The discotic liquid crystalline molecular material is a liquid crystalline compound generally having a structure with a tabular central skeleton of the molecule and a portion with the rich bending properties such as an alkyl chain provided around that. For immobilizing the discotic liquid crystalline molecules by polymerization, a polymerizable group should be bonded as a substituent with the disk-like core of the discotic liquid crystalline molecule. However, if the polymerizable group is directly bonded with the disk-like core, the alignment state can hardly be maintained in the polymerization reaction. Thus, a linking group is introduced between the disk-like core and the polymerizable group.

The liquid crystal layer forming ink composition of the present invention comprises an organic solvent for dissolving or dispersing the liquid crystalline molecular material explained above, and an alcohols solvent. As the organic solvent for dissolving or dispersing the liquid crystalline molecular material, ketone based solvents such as methyl ethyl ketone (MEK), methyl isobutyl ketone (MIBK) cyclohexanone (also abbreviated as anone) and methyl cyclohexanone can be used preferably because they can particularly-easily dissolve the liquid crystalline molecular material. The organic solvent used in the present invention is generally those other than the alcohol based ones. However, depending on the kind of the liquid crystalline molecular material, the kind of the alcohols solvent and the combination thereof, in the case the liquid crystalline molecules can be dissolved or dispersed with an alcohols solvent to the extent sufficiently practical, the alcohols solvent may serve also as the organic solvent for dissolving or dispersing the liquid crystalline molecules. Examples of the alcohols solvent contained in the liquid crystal layer forming ink composition include N-propyl alcohol, i-propyl alcohol, n-butyl alcohol, i-butyl alcohol, ethyl alcohol, and 4-hydroxy-4 methyl-2-pentanone 1-butanol. The solvent in the liquid crystal layer forming ink composition in the present invention is a mixture of the organic solvent for dissolving or dispersing the above-mentioned liquid crystalline molecular material and the alcohols solvent. The composition of the organic solvent and the alcohols solvent is: 5 to 50 parts and preferably 10 to 30 parts of the alcohols solvent with respect to 100 parts of the organic solvent. If the ratio of the alcohols solvent is low, the function of laying the coated liquid crystalline molecules on the base material is insufficient, the transparency is lowered and the Haze is made higher. On the other hand, if the ratio of the alcohols solvent is too high, the solubility of the liquid crystalline molecular material in the ink composition comes to insufficient, so that troubles are generated in terms of the coating suitability and the optical characteristics.

Although the alcohols solvent is not for dissolving the liquid crystalline molecular material, the alcohols solvent is considered to have the function of facilitating the liquid crystalline molecular material to be in a horizontally aligned state instead of an upright state on the base material at the time of being applied on the base material. That is, the alcohols solvent is considered to have a function similar to a lubricating agent in the liquid crystal layer forming ink composition, or a function of improving leveling of the film coated on the base material. An optical film provided with a liquid crystal layer on a base material with such a liquid crystalline molecular material in a horizontally aligned state on a base material has a high transparency without clouding, that is, a low Haze and contrast display is high when viewed from the front side.

The liquid crystal layer forming ink composition of the present invention comprises a liquid crystalline molecular material, an organic solvent for dissolving or dispersing the molecular material and an alcohols solvent. In the case the liquid crystalline molecular material is of a photo setting type, it is preferable to further add a photo polymerization initiating agent. Examples of an additive include the above-mentioned chiral agent; a silicon based leveling agent such as polydimethyl siloxane, methyl phenyl siloxane, and organic modified siloxane; a straight chain-like polymerized product such as polyalkyl acrylate and polyalkyl vinyl ether; a fluorine based leveling agent such as a fluorine based surfactant and tetrafluoro ethylene; and a hydrocarbon based surfactant. Although not particularly limited thereto, the concentration of the liquid crystalline molecular material in the all solvent including the organic solvent and the alcohols solvent in the above-mentioned liquid crystal layer forming ink composition of the present invention is preferably in a range of 5% by mass to 40% by mass, and particularly in a range of 15% by mass to 30% by mass.

### B. Optical Film Produced Using the Liquid Crystal Layer Forming Ink Composition

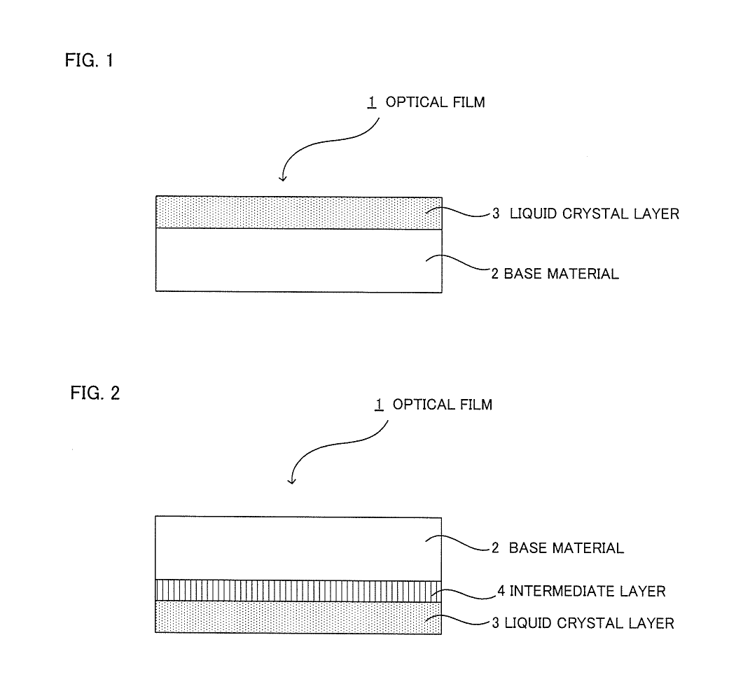

The optical film of the present invention is obtained by applying the liquid crystal layer forming ink composition explained above on the base material, and drying for removing the organic solvent and the alcohols solvent of the ink composition so as to align the liquid crystalline molecular material for forming the liquid crystal layer on the base material. FIG. 1 is a cross-sectional view showing an example of an optical film of the present invention. The example shown in FIG. 1 is an optical film 1 having a liquid crystal layer 3, which contains a liquid crystalline molecular material, formed on one side surface of a base material 2. FIG. 2 is a cross-sectional view showing another example of the optical film of the present invention. The example is an optical film 1 having a liquid crystal layer 3, which contains a liquid crystalline molecular material, formed on one side surface of a base material 2 via an intermediate layer 4. The intermediate layer is provided for improving the adhesiveness between the base material and the liquid crystal layer.

The base material as the constituent element of the optical film is used with the liquid crystal layer forming ink composition applied and dried on the base material for removing the organic solvent and the alcohols solvent of the ink composition so as to have the liquid crystal layer formed in a state with the liquid crystalline molecular material aligned. The base material is not particularly limited as long as a trouble is not generated on the base material surface state or the endurance by the process of heating or the like at the time of aligning the liquid crystalline molecular material. Examples of the base material include a film made of a transparent polymer film, for example, a polycarbonate based polymer, an acrylic based polymer such as polymethyl methacrylate, a polyester based polymer such as polyethylene terephthalate and polyethylene naphthalate, and a cellulose based polymer such as diacetyl cellulose and triacetyl cellulose.

Furthermore, examples of the base material include a film of a transparent polymer, for example, an olefin based polymer such as polyethylene, polypropylene, polyolefin having a cyclic or norbornene structure, and an ethylene-propylene copolymer; a styrene based polymer such as polystyrene and an acrylonitrile-styrene copolymer; a vinyl chloride based polymer; and an amide based polymer such as aromatic polyamide. As to the transparent base material, the average light transmittance of a visible light (380 nm to 780 nm) is 50% or more, preferably 70% or more, more preferably 85% or more. For the light transmittance measurement, the value measured in the atmosphere at room temperature with an ultraviolet and visible spectrophotometer (for example, UV-3100PC produced by Shimadzu Corporation) is used. Among the base materials presented above, because the various kinds of excellent optical characteristics, triacetyl cellulose, polycarbonate, norbornene polyolefin, or the like can be used particularly preferably.

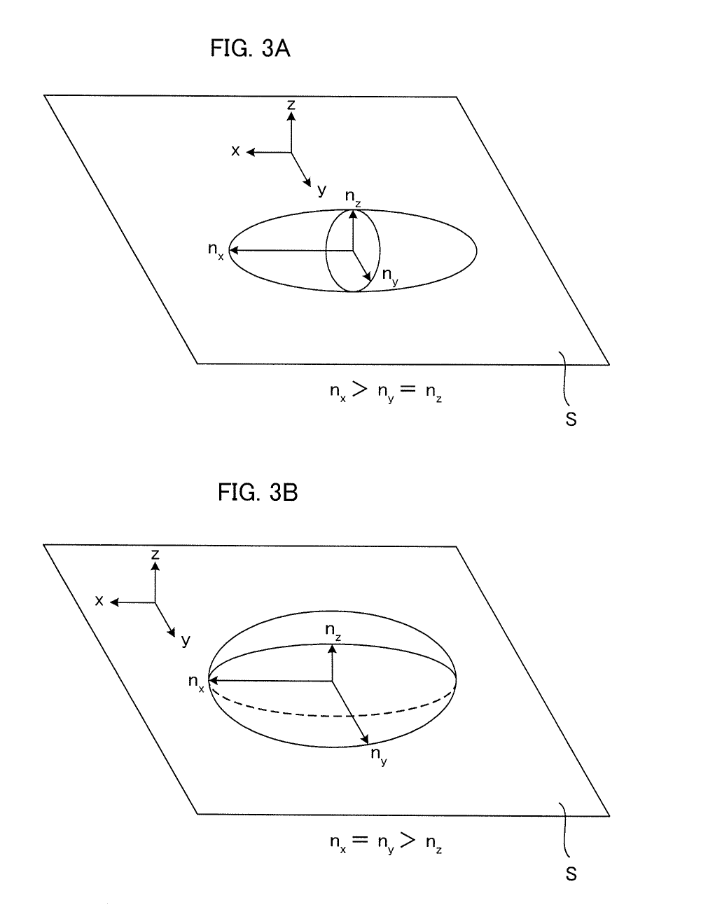

A film produced by drawing the resin such as the above-mentioned polycarbonate, which functions as a “positive A plate” may also be used. Here, as shown in FIG. 3A, with the z axis taken in the normal direction of the layer surface “S”; the x axis and y axis taken in the orthogonal directions in the layer surface “S”; and the refractive indices in the x axis direction, y axis direction and z axis direction provided as nx, ny, nz, respectively, a retardation layer with the relationship of: nx>ny=nz is the retardation layer having optically-positive uniaxial properties in the layer surface “S”, which is referred to as a “positive A plate”. Accordingly, a drawn polymer film or a film without a drawing treatment may also be used according to the demand of the optical characteristics to be used. As to the film thickness of the base material of the optical film, in general, one in a range of 10 μm to 200 μm can be used, and in particular, one in a range of 20 μm to 100 μm can be used preferably.

To the base material constituting the optical film, an alignment film may be formed by the depositing treatment of an inorganic material or by providing an organic coated film and applying the rubbing treatment to the surface, or an alignment treatment such as a drawing treatment of the base material or the like may be applied. In the present invention, a liquid crystal layer can be formed particularly preferably to a base material with no alignment treatment applied. Since the above-mentioned various kinds of alignment treatment are not efficient in terms of the industrial productivity so as to involve many problems such as the low product yield, it is preferable to form a liquid crystal layer by applying a liquid crystal layer forming ink composition of the present invention on a base material with no alignment treatment applied.

An intermediate layer 4 may be provided between the base material and the liquid crystal layer for improving the adhesion properties therebetween. The intermediate layer may be provided with a resin to be cured by the cross-linking reaction, or the like through an active ray irradiation such as an ultraviolet ray and an electron beam, that is, an active ray curable resin, or a thermosetting resin. One to be used particularly preferably is an active ray curable resin. Specifically, a compound including an ethylenically unsaturated group can be presented. Preferable examples thereof include polyacrylates of a polyol such as ethylene glycol diacrylate, trimethylol propanetriacrylate, ditrimethylol propane tetraacrylate, pentaerythritol triacrylate, pentaerythritol tetraacrylate, dipentaerythritol pentaacrylate, and dipentaerythritol hexaacrylate; epoxy acrylates such as a diacrylate of bisphenol A diglycidyl ether, and a diacrylate of hexane diol diglycidyl ether; and a urethane acrylate obtained by the reaction of polyisocyanate and a hydroxyl group containing acrylate such as hydroxyl ethyl acrylate. These compounds may be used alone or in combination.

The intermediate layer can be formed by preparing a coating solution by dissolving or dispersing the curable resins explained above in an organic solvent, applying the same with a conventionally known coating method such as a bar coating, a blade coating, a spin coating, a die coating, a slit reverse, a roll coating, a dip coating, an ink jet method and a micro gravure method, and drying by the active ray irradiation or hot air. The film thickness of the intermediate layer is about 0.1 g/m² to 5 g/m² in a state after drying. Since the rubbing treatment of rubbing the surface with a cloth of cotton, nylon, polyester or the like in a certain direction is not carried out for the intermediate layer, fluff or dusts are not generated by the surface friction.

By applying a liquid crystal layer forming ink composition of the present invention on the base material explained above or via the intermediate layer for forming the liquid crystal layer, the optical film can be obtained. The coating method of the liquid crystal layer is not particularly limited as long as it is a method capable of evenly applying the liquid crystal layer forming ink composition explained above on the base material. For example, a bar coating, a blade coating, a spin coating, a die coating, a slit reverse, a roll coating, a dip coating, an ink jet method and a micro gravure method can be cited. Among them, the blade coating, the die coating, the slit reverse and the roll coating is preferable in the present invention since they can form an even coated film. As to the liquid crystal layer forming ink composition, a solvent mixture of the organic solvent for dissolving or dispersing the liquid crystalline molecular material and the alcohols solvent is used as mentioned above. For the efficient production by shortening the drying time in the drying operation after the application, a solvent having a relatively low boiling point such as toluene and ethyl acetate is added to the above-mentioned solvent mixture.

As mentioned above, the film thickness of the liquid crystal layer to be applied differs depending on the retardation level of the optical film to be obtained (retardation value). The thickness is preferably, in a state after drying, in a range of 0.8 g/m² to 6 g/m², particularly preferably in a range of 1.6 g/m² to 5 g/m². As mentioned above, for removing the organic solvent and the alcohols solvent of the ink composition, the drying operation is carried out after the application of the liquid crystal layer forming ink composition. As to the drying conditions, in general, the drying operation is carried out at room temperature to 120° C., preferably in a range of 70° C. to 100° C., for about 30 seconds to 10 minutes, preferably for about 1 minute to 5 minutes. By the drying operation, the organic solvent and the alcohols solvent of the ink composition are removed, and moreover, the liquid crystalline molecular material is aligned in the horizontal direction of the coated surface of the base material. Moreover, in the case where the ink composition is produced by adding a chiral agent to a nematic liquid crystal, the liquid crystalline molecules are spirally aligned in which the molecules are aligned horizontally to the flat surface of the base material.

In the above-mentioned aligning operation, a heat treatment for aligning the liquid crystalline molecular material may be added independently of the drying conditions after the application of the liquid crystal layer forming ink composition.

It is preferable to immobilize the liquid crystal layer after the application of the liquid crystal layer forming ink composition on the base material and drying for removing the organic solvent and the alcohols solvent of the ink composition so as to align the liquid crystalline molecular material. In the case where the liquid crystalline molecular material to be used has a polymerizable functional group, the immobilization is carried out for polymerizing the liquid crystalline molecular material to be a polymer. According to the immobilization, elution of the liquid crystalline molecular material from the liquid crystal layer after provided on a plastic film can be prevented so that the stability of the optical film to be obtained can be improved. As to the immobilization, various methods can be used depending on the liquid crystalline molecular material to be used. For example, in the case the liquid crystalline molecular material is a cross-linkable compound, the immobilization is carried out by including a photo polymerization initiating agent and directing an ultraviolet ray or an electron beam. Alternatively, in the case it is a thermosetting compound, the immobilization is carried out by heating.

As mentioned above, in the case the liquid crystal layer formed on the base material is aligned using for example a liquid crystalline molecular material with the molecular structure containing a chiral agent, it functions so as to be used as a “negative C plate” when aligned. Here, as shown in FIG. 3B, a retardation layer having the relationship of: nx=ny>nz is the retardation layer having optically-negative uniaxial properties in the normal direction of the layer surface “S”, which is referred to as a “negative C plate”. The liquid crystal layer formed on the base material has the liquid crystalline molecular material of the liquid crystal layer forming ink composition dissolved or dispersed with the organic solvent, and the liquid crystal layer contains the alcohols solvent. For this reason, the liquid crystalline molecular material is in a state aligned horizontally on the base material so that a high transparency and a low Haze can be enabled. The obtained optical film has the average light transmittance of a visible light (380 nm to 780 nm) of 50% or more, preferably 70% or more, and more preferably 85% or more. Furthermore, the Haze is measured based on the method defined in the JIS K 7361, and the Haze value is 0.17 or less.

### C. Polarizing Film

By directly attaching a polarizing layer onto the optical film explained above with a polyvinyl alcohol (PVA) based adhesive or the like, a polarizing film can be optimized and utilized. In general, the polarizing film is used in a state with a protection film attached on both side surfaces of the polarizing layer. According to the present invention, one of the protection films can be the above-mentioned optical film. Therefore, for example, in the case where an optical compensator is needed additionally, it is advantageous in that an additional optical compensator needs not be provided by use of the polarizing film of the present invention.

The above-mentioned optical film can be utilized as an optical functional film in a state directly attached to an optical functional layer such as a reflection preventing layer, a ultraviolet ray absorbing layer and an infrared ray absorbing layer. For example, the function of the optical film of the present invention such as the optical compensation, and another function such as the reflection prevention can be provided by one film, therefore, it is advantageous in that films having each function need not be provided independently.

### D. Liquid Crystal Display

A display with any of the above-mentioned optical film, the polarizing film and the optical functional film according to the present invention arranged on the optical path can be obtained. Since the optical film according to the present invention having an appropriate retardation without a problem of peel-off or the like is arranged, a highly reliable display having the excellent display quality can be obtained. Moreover, since the polarizing film according to the present invention is arranged, a display having the excellent display quality can be obtained without the need of additionally providing an optical compensator.

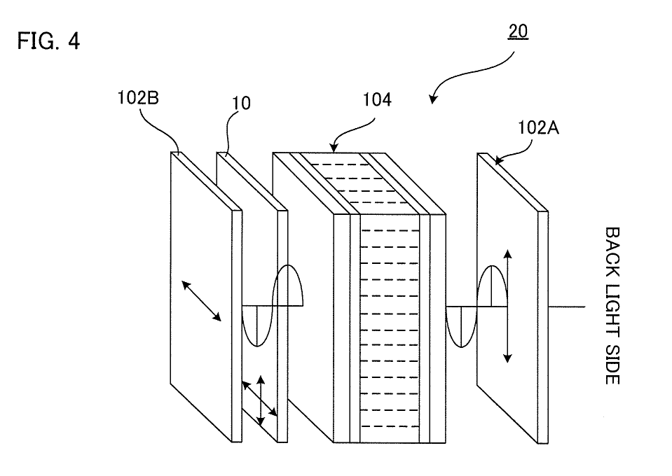

FIG. 4 is a perspective view showing an example of a liquid crystal display as a display of the present invention. As shown in FIG. 4, the liquid crystal display 20 of the present invention comprises an incident side polarizing plate 102A, an outgoing side polarizing plate 102B, and a liquid crystal cell 104. The polarizing plates 102A and 102B are provided so as to selectively transmitting only a linear polarization having an oscillation surface in a predetermined oscillation direction, arranged in the cross Nicols state with the oscillation directions perpendicular to each other. The liquid crystal cell 104 including a large number of cells corresponding to the pixels is arranged between the polarizing plates 102A and 102B.

Here, in the liquid crystal display 20, the liquid crystal cell 104 employs the VA (vertical alignment) system with a nematic liquid crystal having the negative dielectric anisotropy. At the time of transmitting the portion of a cell in a non-driven state out of the liquid crystal cell 104, a linear polarization transmitted the incident side polarizing plate 102A transmits without the phase shift so as to be blocked by the outgoing side polarizing plate 102B. On the other hand, at the time of transmitting the portion of a cell in a driven state out of the liquid crystal cell 104, the linear polarization has the phase shift, so that a light beam of an amount according to the phase shift amount transmits the outgoing side polarizing plate 102B so as to be to go out. Thereby, the driving voltage of the liquid crystal cell 104 can be controlled optionally per each cell, so that a desired image can be displayed on the outgoing side polarizing plate 102B side.

According to the liquid crystal display 20 having such a configuration, the above-mentioned optical film 10 of the present invention is arranged on the optical path between the liquid crystal cell 104 and the outgoing side polarizing plate 102B (the polarizing plate for selectively transmitting a light beam in a predetermined polarizing state gone out from the liquid crystal cell 104). Therefore, the polarizing state of a light beam to go out in a direction inclined with respect to the normal of the liquid crystal cell 104 out of the light beam in a predetermined polarizing state gone out from the liquid crystal cell 104 can be compensated.

As mentioned above, according to the liquid crystal display 20 of the above-mentioned configuration, the highly reliable optical film 10 according to the present invention mentioned above is arranged between the liquid crystal cell 104 and the outgoing side polarizing plate 102B of the liquid crystal display 20 so that the polarizing state of the light beam to go out in a direction inclined with respect to the normal of the liquid crystal cell 104 out of the light beam outgoing from the liquid crystal cell 104. Consequently, the problem of the viewing angle dependency in the liquid crystal display 20 can be improved effectively so that the excellent display quality and the high reliability can be enabled.

Although the liquid crystal display 20 shown in FIG. 4 is of the transmission type of transmitting a light beam from one side to the other side in the thickness direction, embodiments of the display according to the present invention is not limited thereto, and the above-mentioned optical film 10 according to the present invention can be assembled in a reflection type liquid crystal display and used in the same manner. Furthermore, the optical film 10 can be assembled and used in the same manner on the optical path of the display other than the above-mentioned, such as an organic EL display.

Although the above-mentioned optical film 10 according to the present invention is arranged between the liquid crystal cell 104 and the outgoing side polarizing plate 102B in the liquid crystal display 20 shown in FIG. 4, the optical film 10 may be arranged between the liquid crystal cell 104 and the incident side polarizing plate 102A depending on the aspect of the optical compensation. Moreover, the optical film 10 may be arranged on both sides of the liquid crystal cell 104 (between the liquid crystal cell 104 and the incident side polarizing plate 102A, and between the liquid crystal cell 104 and the outgoing side polarizing plate 102B). The number of the optical film to be arranged between the liquid crystal cell 104 and the incident side polarizing plate 102A, or between the liquid crystal cell 104 and the outgoing side polarizing plate 102B is not limited to one, and the optical film may be arranged in plurality. Furthermore, another optical functional film may be arranged on the optical path.

### EXAMPLES

Hereafter, the present invention will be explained specifically with reference to the examples.

### Example 1

A nematic liquid crystal having acrylate as a polymerization group on both ends of the molecules, and a chiral agent having acrylate as a polymerization group on both ends of the molecules were dissolved in a solvent mixture of: cyclohexanone:toluene:isopropyl alcohol=2:3:3 by 20% by mass based on % by mass. Then, a photo polymerization initiating agent (IRUGACURE 907 produced by Nihon Ciba-Geigy K.K.) was prepared to be 1% by mss with respect to the total mass of the nematic liquid crystal and the chiral agent, a liquid crystal solution, that is, a liquid crystal layer forming ink composition was produced.

The ink composition was applied on the base material of an 80 μm thickness triacetyl cellulose (TAC) film with saponification treatment applied by the bar coat method.

After drying the same for 2 minutes in an 80° C. oven, a 100 mJ/cm² ultraviolet ray was directed under nitrogen atmosphere for curing the ink composition to form a liquid crystal layer, and an optical (compensation) film was produced. Then, the Haze of the optical film produced as mentioned above was measured, commercially available polarizing plates (HCL2-5618HCS, produced by SANRITZ CORPORATION) were attached on both sides of the optical film in a cross Nicols state and placed on a back light for the liquid crystal, and the degree of clouding on the front side was observed and evaluated visually in a dark room. The Haze was measured based on the method defined in the JIS K 7361.

The criteria of evaluating the degree of clouding were as follows.

O: No clouding observed, with high transparency and good.
x: Clouding observed, with low transparency and poor.

### Example 2

An optical film was produced in the same manner as in Example 1 except that the % by mass ratio of the solvent mixture was changed to: cyclohexanone:toluene:isopropyl alcohol=3.5:3.5:1. Moreover, in the same manner as in Example 1, the Haze of the obtained optical film was measured, commercially available polarizing plates were attached on both sides of the optical film in a cross Nicols state and placed on a back light for the liquid crystal, and the degree of clouding on the front side was observed and evaluated visually in a dark room.

### Example 3

A nematic liquid crystal having acrylate as a polymerization group on both ends of the molecules, and a chiral agent having acrylate as a polymerization group on both ends of the molecules were dissolved in a solvent mixture of: cyclohexanone:toluene:isopropyl alcohol 2:3:3 by 20% by mass based on % by mass. Then, a photo polymerization initiating agent (IRUGACURE 907 produced by Nihon Ciba-Geigy K.K.) was prepared to be 1% by mss with respect to the total mass of the nematic liquid crystal and the chiral agent, a liquid crystal solution, that is, a liquid crystal layer forming ink composition was produced.

Dipentaerythritol hexaacrylate was applied on the base material of an 80 μm thickness triacetyl cellulose (TAC) film by the bar coat method. After drying the same for 2 minutes in a 100° C. oven, a 100 mJ/cm² ultraviolet ray was directed under nitrogen atmosphere for curing the ink composition to form an intermediate layer of a 0.12 μm thickness. On the intermediate layer of the obtained TAC film with the intermediate layer, the above-mentioned liquid crystal layer forming ink composition was applied by the bar coat method. After drying the same for 2 minutes in an 80° C. oven, a 100 mJ/cm² ultraviolet ray was directed under nitrogen atmosphere for curing the ink composition to form a liquid crystal layer, and an optical (compensation) film was produced. Then in the same manner as in Example 1, the Haze of the obtained optical film was measured, commercially available polarizing plates were attached on both sides of the optical film in a cross Nicols state and placed on a back light for the liquid crystal, and the degree of clouding on the front side was observed and evaluated visually in a dark room.

### Example 4

A liquid crystal layer was formed on an intermediated layer of a TAC film and an optical film was produced in the same manner as in Example 3 except that the % by mass ratio of the solvent mixture was changed to: cyclohexanone:toluene:isopropyl alcohol=3.5:3.5:1. Moreover, in the same manner as in Example 1, the Haze of the obtained optical film was measured, commercially available polarizing plates were attached on both sides of the optical film in a cross Nicols state and placed on a back light for the liquid crystal, and the degree of clouding on the front side was observed and evaluated visually in a dark room.

### Comparative Example 1

An optical film was produced in the same manner as in Example 1 except that a solvent mixture was made only by cyclohexanone and toluene, and the % by mass ratio of the solvent mixture was changed to: cyclohexanone:toluene:=1:1. Moreover, in the same manner as in Example 1, the Haze of the obtained optical film was measured, commercially available polarizing plates were attached on both sides of the optical film in a cross Nicols state and placed on aback light for the liquid crystal, and the degree of clouding on the front side was observed and evaluated visually in a dark room.

### Comparative Example 2

A liquid crystal layer was formed on an intermediated layer of a TAC film and an optical film was produced in the same manner as in Example 3 except that a solvent mixture was made only by cyclohexanone and toluene, and the % by mass ratio of the solvent mixture was changed to: cyclohexanone:toluene=1:1. Moreover, in the same manner as in Example 1, the Haze of the obtained optical film was measured, commercially available polarizing plates were attached on both sides of the optical film in a cross Nicols state and placed on a back light for the liquid crystal, and the degree of clouding on the front side was observed and evaluated visually in a dark room.

The measurement results of the Haze and evaluation results of clouding observed visually in the above-mentioned examples and comparative examples are shown in the following table 1.

TABLE 1

| | | Visually-observed |
|---|---|---|
| | Haze | clouding |
| Example 1 | 0.15 | ◯ |
| Example 2 | 0.14 | ◯ |
| Example 3 | 0.16 | ◯ |
| Example 4 | 0.15 | ◯ |
| Comparative Example 1 | 0.20 | X |
| Comparative Example 1 | 0.21 | X |

In the all optical films obtained in Examples 1 to 4 the Haze was 0.16 or less and transparency was high. As to the clouding observed visually, clouding was not observed in any of the optical films, and the optical films were with a high transparency and good. On the other hand, in Comparative Examples 1 and 2, the optical films were with the Haze of 0.20 or more and had a low transparency. Moreover, as to the clouding observed visually, clouding was observed, and the transparency was lowered and thus the optical films were poor.

1-9. (canceled)

10. A liquid crystal layer forming ink composition, wherein a liquid crystalline molecular material, an organic solvent for dissolving or dispersing the molecular material, and an alcohols solvent are contained.

11. The liquid crystal layer forming ink composition according to claim 10, wherein the liquid crystalline molecular material is a nematic liquid crystalline molecular material and further contains a chiral agent.

12. The liquid crystal layer forming ink composition according to claim 10, wherein the liquid crystalline molecular material has a polymerizable functional group.

13. An optical film, wherein a liquid crystal layer is formed by: applying the liquid crystal layer forming ink composition according to claim 10 on a base material with no alignment treatment applied, and drying for removing the organic solvent and the alcohols solvent of the ink composition so as to align the liquid crystalline molecular material.

14. An optical film, wherein a liquid crystal layer is formed by: applying the liquid crystal layer forming ink composition according to claim 11 on a base material with no alignment treatment applied, and drying for removing the organic solvent and the alcohols solvent of the ink composition so as to align the liquid crystalline molecular material.

15. An optical film, wherein a liquid crystal layer is formed by: applying the liquid crystal layer forming ink composition according to claim 12 on a base material with no alignment treatment applied, and drying for removing the organic solvent and the alcohols solvent of the ink composition so as to align the liquid crystalline molecular material.

16. An optical film, wherein a liquid crystal layer is formed by: applying the liquid crystal layer forming ink composition according to claim 12 on a base material with no alignment treatment applied, and drying for removing the organic solvent and the alcohols solvent of the ink composition so as to align the liquid crystalline molecular material, followed by immobilization.

17. An optical film, wherein a liquid crystal layer with the liquid crystalline molecular material aligned is formed by: applying the liquid crystal layer forming ink composition according to claim 10 on a base material with an alignment treatment applied, and drying for removing the organic solvent and the alcohols solvent of the ink composition.

18. An optical film, wherein a liquid crystal layer with the liquid crystalline molecular material aligned is formed by: applying the liquid crystal layer forming ink composition according to claim 11 on a base material with an alignment treatment applied, and drying for removing the organic solvent and the alcohols solvent of the ink composition.

19. An optical film, wherein a liquid crystal layer with the liquid crystalline molecular material aligned is formed by: applying the liquid crystal layer forming ink composition according to claim 12 on a base material with an alignment treatment applied, and drying for removing the organic solvent and the alcohols solvent of the ink composition.

20. An optical film, wherein a liquid crystal layer is formed by: applying the liquid crystal layer forming ink composition according to claim 12 on a base material with an alignment treatment applied, and drying for removing the organic solvent and the alcohols solvent of the ink composition so as to align the liquid crystalline molecular material, followed by immobilization.

21. A polarizing film comprising the optical film according to claim 13 attached with a polarizing layer.

22. A polarizing film comprising the optical film according to claim 14 attached with a polarizing layer.

23. A polarizing film comprising the optical film according to claim 15 attached with a polarizing layer.

24. A liquid crystal display, wherein the optical film according to claim 13 is arranged on an optical path.

25. A liquid crystal display, wherein the optical film according to claim 14 is arranged on an optical path.

26. A liquid crystal display, wherein the optical film according to claim 15 is arranged on an optical path.

27. A liquid crystal display, wherein the polarizing film according to claim 21 is arranged on an optical path.

28. A liquid crystal display, wherein the polarizing film according to claim 22 is arranged on an optical path.

29. A liquid crystal display, wherein the polarizing film according to claim 23 is arranged on an optical path.
